(19) United States
(12) Patent Application Publication
(10) Pub. No.: US 2008/0172887 A1
(43) Pub. Date: Jul. 24, 2008

(54) Cutting Device and Associated Methods

(76) Inventor: Jack G. Potter, Rockledge, FL (US)

Correspondence Address: Zies, Widerman, Sutch & Malek, P.L., 202 N. Harbor City Blvd, Suite #200, Melbourne, FL, 32935, US

(21) Appl. No.: 11/625,469

(22) Filed: Jan. 22, 2007

(51) Int. Cl. B26B 13/00

(52) U.S. Cl. 30/244

(57) ABSTRACT

A cutting device or food scissor apparatus includes a first cutting element which has a shank section, a first handle, and a blade section with a cutting edge and a second cutting element having a shank section, a second handle, and a blade section with a cutting edge and an endpoint. The first and second cutting elements of the apparatus are connected about a rotational pin. The apparatus includes an orthogonal tip connected to the endpoint of the second cutting element. Various tip designs may be removably attached to the apparatus. The perpendicular tip promotes cutting stability and reduces damages to a surface from which material is being cut.

### FIELD OF THE INVENTION

This invention generally relates to food preparation devices and in particular to providing a device and method for grasping and cutting food with ease and precision.

### BACKGROUND OF THE INVENTION

Various types of food cutting devices exist within the art. Rotary cutting devices, such as wheeled pizza cutters are common. However, rotary pizza cutters notoriously damage cooking pans or other surface areas. Increased damage to surfaces significantly contributes to increased bacterial build-up and other forms of unsanitary environments. Thus, food cutting devices which damage surfaces possibly lead to food contamination and require additional or rigorous cleaning of related equipment.

Other cutting devices have non-sharp tips for safety purposes, such as children's scissors which commonly feature blades with rounded or blunt tips. Some scissors, such as fabric scissors, may also have blunt tips. However, such scissors do not provide protruding orthogonal tips for lifting and minimizing damage to surface areas.

Kitchen scissors commonly incorporate straight shank elements and cutting blades with pointed tips. Cutting devices or scissors having one or both blades inclined from the shanks elements have been produced. However, such devices have proven unsatisfactory for cutting food from a flat position for one or more reasons. Moreover, these cutting devices provide minimal stabilization to conduct cutting operations across flat surfaces.

### SUMMARY OF THE INVENTION

The present invention relates to utensils primarily designed for cutting food or other materials from a flat position. In particular, the present invention is directed to food scissors having a protruding orthogonal tip, whereby the protrusion lifts food from a flat surface to provide easier cutting. The present invention advantageously reduces scratching of surface areas and increases cutting stability across a flat surface.

These and other features, advantages and benefits of the present invention are provided by a cutting device for lifting and cutting material or food from a substantially flat surface. The invention includes a pair of opposed cutting edges and a protruding tip orthogonally oriented from the lower cutting edge of the invention. Upon operation of the cutting edges a cutting action is performed wherein the tip promotes lifting and cutting stability. The protruding tip may be manufactured orthogonal to the lower cutting edge, but may also include a removable attachment to the lower cutting edge. Thus, various tip designs may be incorporated within the present invention for improved lifting and cutting operations.

One embodiment of the present invention takes the form of a cutting device which includes a first cutting element having a shank section, a first handle, and a blade section with a cutting edge. This embodiment also includes a second cutting element having a shank section, a second handle, and a blade section with a cutting edge and an endpoint. The first and second cutting elements are connected via a rotational pin. The embodiment includes an orthogonal tip connected to the endpoint of the second cutting element.

In another embodiment, the present invention takes the form of angular food scissors which includes a first cutting element having a shank section, a first handle section, and a blade section with an upper cutting edge. The embodiment includes a second cutting element having a shank section, a second handle section, and a blade section with a lower cutting edge and an endpoint. In this embodiment, the shanks are inclined from the cutting edges. The first and second cutting elements are pivotally united at a point intermediate the blade and shank sections to cause the cutting edges to engage each other to provide a cutting action. The embodiment includes a protruding orthogonal tip which is connected to the endpoint of the second cutting element, wherein the tip extends orthogonally from the lower cutting edge.

In yet another embodiment, the present invention takes the form of scissors having angular shanks and a protruding orthogonal tip to lift food from a flat surface, such as a cooking pan. The present invention is designed to cut food from a flat position and reduce scratches made to a surface. The protruding tip is designed to orthogonally extend from the lower cutting edge of the scissors to lift material or food for cutting. The orthogonal tip extension dimensions are advantageously designed for structural strength to lift food, while avoiding cumbersome operation. Accordingly, one embodiment of the present invention includes a protruding tip that extends orthogonally from the lower cutting blade, wherein the width of the tip is approximately one-half inch on each side of the lower cutting blade.

In the exemplary embodiment the device may include a removably attached orthogonal tip. Various orthogonal tip designs may be selected based on cutting needs such as speed, strength, or lifting.

### BRIEF DESCRIPTION OF THE DRAWINGS

FIG. 1 is a perspective view of a cutting device in an opened position according to the invention.

FIG. 2 is a side elevation view of a second embodiment of the cutting device according to the present invention.

FIG. 3 is a bottom plan view of the cutting device illustrated in FIG. 1.

FIG. 4a is a partial side elevation view of a second embodiment of the cutting device according to the present invention.

FIG. 4b is a partial bottom plan view of the cutting device illustrated in FIG. 4a.

FIG. 5a is a partial elevation view of a third embodiment of the cutting device illustrating an orthogonal protruding tip.

FIG. 5b is a partial elevational view of the fourth embodiment of the cutting device, illustrating the orthogonal protruding tip shown in FIG. 5a.

FIG. 6a is a side elevation view of a fifth embodiment of a grabbing utensil.

FIG. 6b is a bottom plan view of the grabbing utensil illustrated in FIG. 6a.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

One embodiment of the present invention takes the form of a device for cutting material from a flat surface. The embodiment, in general, includes a cutting device 10 that has two cutting edges which are pivotally connected to cause the cutting edges to engage each other with a cutting action when handles sections of the cutting device are moved into contact with each other. In other words, the handle sections and cutting sections may be moved between opened and closed positions. At the distal end of one of the cutting edges is a protruding tip that is perpendicularly oriented from the cutting edges. The tip lifts material to be cut from a surface. The orthogonal tip 70 advantageously promotes cutting stability and reduces possible damage to the surface typically caused by sharp or pointed cutting devices. For example, the orthogonal tip 70 prevents gouging of certain surface material, such as cooking pans or valuable kitchen surfaces. The orthogonal tip 70 simultaneously prevents lateral or angular movement of the cutting device 10 during cutting action.

Another embodiment may include scissors 100 which may have shanks inclined from the cutting edges. The inclined shanks provide greater cutting forces, which combined with an orthogonal tip 150 advances cutting stability. The scissors 100 may also have alternate shanks angles. The inclined angles, measured from a lower cutting edge, may, for example, range from ten degrees (10°) or forty-five degrees (45°).

In another embodiment, the scissors may provide an orthogonal tip that has an inclined edge to promote lifting and further aid in cutting material or food. The embodiment may include a tip that has a width commensurate with a predetermined lifting strength needed for specific materials.

In yet other embodiments, the angular scissors include a tip 210 that is removable or interchangeable. Within this embodiment, the tip 210 is rigidly locked to an endpoint of the lower cutting edge of the scissors. In certain embodiments, the tip 210 shape is varied to provide improved lifting and cutting, while minimizing damage to a surface. For example, the orthogonal tip 210 may include an inclined blunt edge that is curved to promote rapid lifting and eased maneuverability. Alternately, the tip 210 may have a rectangular shape or may have multiple inclined edges.

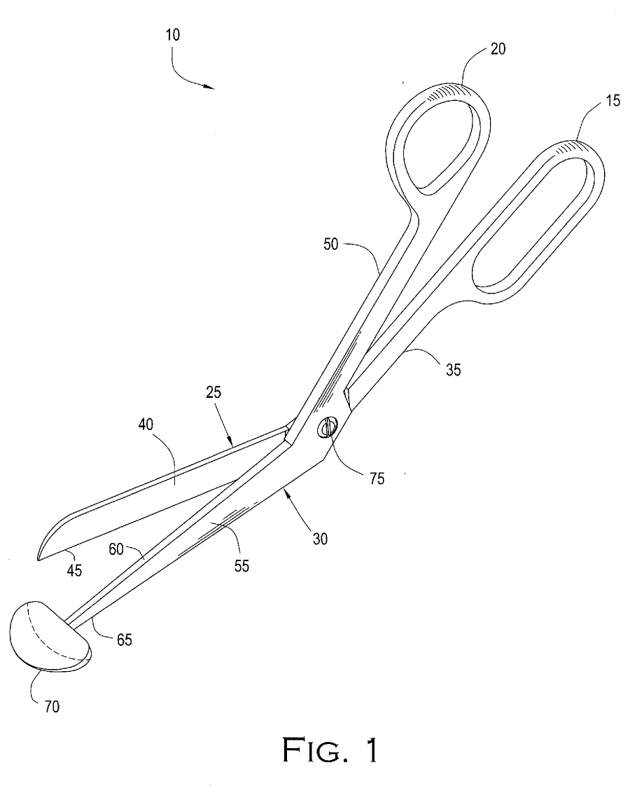

Referring now to the drawings, FIG. 1 illustrates a cutting device 10 operated by a first handle 15 and a second handle 20. The first and second handles 15, 20 move a first cutting element 25 and a second cutting element 30. The first cutting element 25 has a shank section 35, and a blade section 40 which has a cutting edge 45. The second cutting element 30 has a shank section 50, and a blade section 55 which has a cutting edge 60. The second cutting element 30 has an endpoint 65, and the protruding tip 70 is connected thereto. The tip 70 may be molded or bonded to the endpoint 65 by means known within the art. In other words, the tip 70, the blade section 55, the shank section 50, and the second handle may be integrally formed as a monolithic unit. Similarly, the blade section 40, shank section 35, and the first handle may also be integrally formed as a monolithic unit.

In operation, the handles 15, 20 may be moved into contact with each other, causing the union of the upper cutting edge 45 and the lower cutting edge 60 which creates a cutting action. The cutting elements 25, 30 and their respective edges 45, 60 are mated to one another via a rotational pin 75. The rotational pin 75 may generally include a threaded screw coupled with a washer and locking nut, a locking pin, removable pin, or a similar component for pivotally uniting the cutting elements, as understood by those skilled in the art. The handles 15, 20 promote rotation of the cutting elements 25, 30 about the pin 75, where the shanks 35, 50 transmit forces necessary for cutting material, such as meat, pizza, or other food items.

Still referring to FIG. 1, the protruding tip 70 may be orthogonally oriented from the lower cutting edge 60, and secured to the endpoint 65 of the blade section 55. During cutting action the orthogonal tip 70 may provide lifting and cutting stability. In operation, the cutting device 10 with the orthogonal tip 70 may advantageously minimize damage to various surfaces such as pizza pans, kitchen counters, cutting boards, or other kitchen equipment. Decreasing damage to these surfaces advantageously reduces potential bacterial build-up and other forms of unsanitary environments.

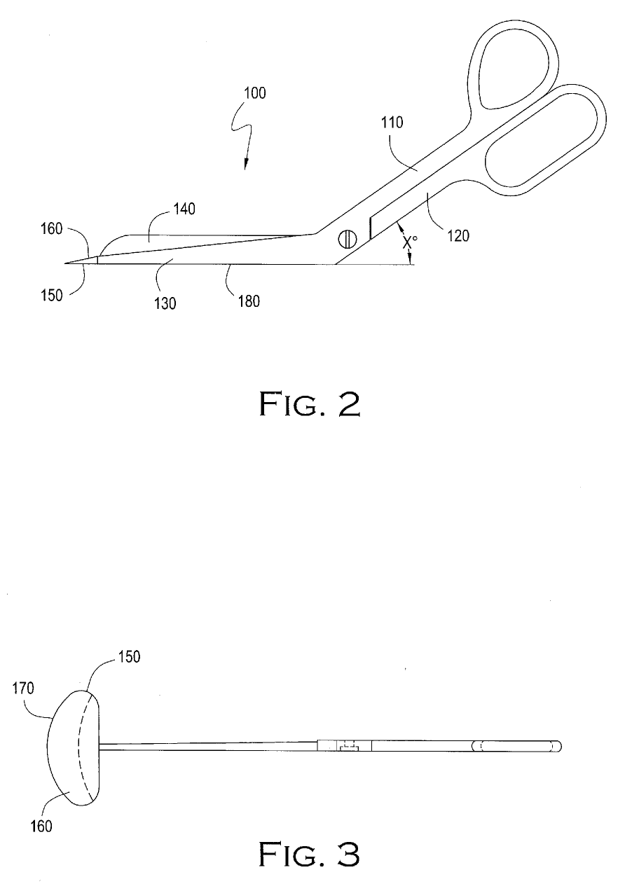

In FIG. 2, angular food scissors 100 are provided in the present invention. The angular food scissors 100 may include an upper shank 110 and a lower shank 120 which may be inclined from the blade sections 130, 140. The inclined features of the shanks 110, 120 advantageously supplement cutting forces during cutting action. As shown in FIG. 2, the angular food scissors 100 may be provided using varied inclination as measured and represented by angle X. The angle may preferably be between about ten degrees (10°) and twenty degrees (20°). Selection of angles may be dependent of the thickness or type metal used to manufacture the present invention. In alternate embodiments, the inclined shanks at angle X may include a more aggressive angle, such as thirty degrees (30°).

The embodiment illustrated in FIG. 2 includes a protruding orthogonal tip 150 which has an inclined edge 160 to lift material for cutting. As perhaps best illustrated in FIG. 3, the angular scissors with the protruding orthogonal tip 150, may include an inclined edge 160 of the tip 150. The inclined edge 160 may include a blunt or rounded leading edge to minimize damage to surfaces. Typically, the protruding tip 150 may be distally curved 170 to further reduce damage to surfaces. The distal curve 170 of the tip 150 may elliptically vary based on intended cutting use. The distal curve 170 may also be dependant of the width of the tip 150. For example, cutting thin pizza may require less lifting force and less tip width, and thus the distal curvature may be nearly circular. In contrast, thicker and heavier pizza, may, for example, require a wider tip, resulting in a broader distal curve.

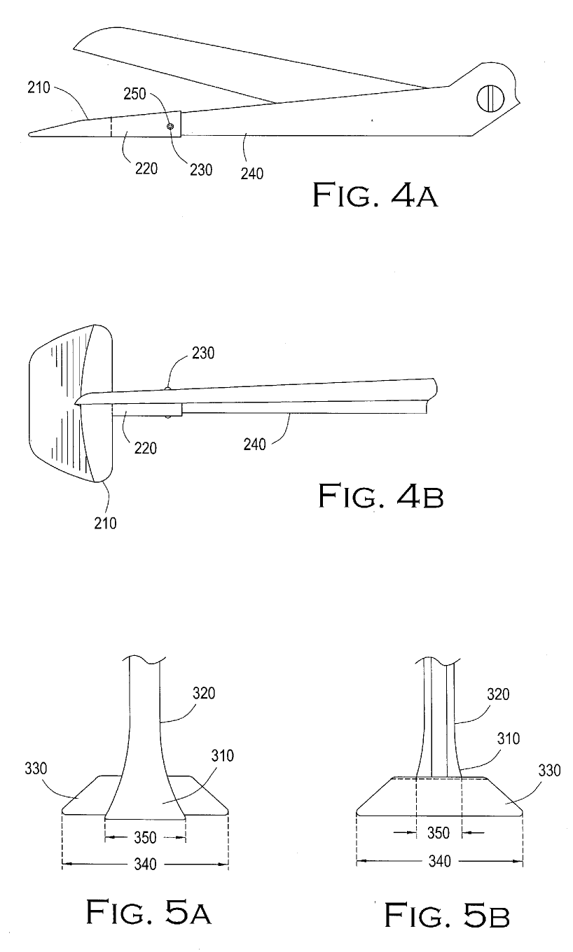

Referring now additionally to FIG. 4a, the angular food scissors may include a protruding tip 210 that is removably attached. The protruding tip 210 may be locked at the blade section endpoint 220 by numerous methods as understood by those skilled in the art. For example, the tip 210 may be compression mounted, locked via a pin, or other similar or equivalent method. As shown in FIG. 4a, the tip 210 is attached to the endpoint 220 via a locking ball 230 mounted in the lower blade section 240. The locking ball 230 may be mounted adjacent the endpoint 220 and the orthogonal tip 210 may be adapted to receive the endpoint and the locking ball. The detachable tip 210 may include a receiving passageway 250 which may be adapted to receive the locking ball 230, further locking the tip rigidly to the endpoint 220 of the blade section 240. As shown in FIG. 4b, the locking ball 230 may engage and lock the tip 210 to the endpoint 220 of the blade section 240. In this case, the shown locking design ensures that the tip is locked to the endpoint prior to commencing a cutting operation. Within the spirit of the invention, the tip 210 may be adapted numerous ways to accommodate various tip features to ensure rigid or sturdy connection. Such features and designs should advantageously accommodate opportunities and ease in thorough cleaning of the cutting device. Thus, depending on the intended cutting environment, parts of the device may be desirably made of material that can be cleaned via high temperature equipment such as autoclaves or industrial washers.

As contemplated within the scope of the invention, interchangeable tips may be designed or shaped to provide improved lifting and cutting, while minimizing damage to a surface. For example, the tip may be rectangular in shape or may have multiple inclined edges. In operation, such interchangeable tips advantageously provide greater lift and stability. Referring to FIG. 5a, cutting stability may be further increased by modifying the width or thickness of an underside 310 of lower blade section 320. In one embodiment, the underside 310 may be widened and tapered with respect to narrower blade section 320. Alternately, the underside 310 and the lower blade section 320 may be the same width (not shown).

In the embodiment shown in FIG. 5a, cutting stability may be improved by modifying widths of the orthogonal tip and the underside of the lower blade section. The orthogonal tip 330 may be a predetermined width 340 and underside 310 may have a second predetermined width 350. The underside width 350 is dependent of the tip width 340, which, by way of example, may be a two to one (2:1) ratio of tip width to underside width. Width ratios may be varied for cutting environments, and such variations are considered within the spirit of the invention. Alternately shown is FIG. 5b, the opposing end view of the embodiment is provided to help understand the approximate ratio of the embodiment shown in FIG. 5a. The combination of interchangeable tip 330, its width 340, and the underside width 350 of the blade section 320 advantageously offers improved maneuverability and stability in cutting operations.

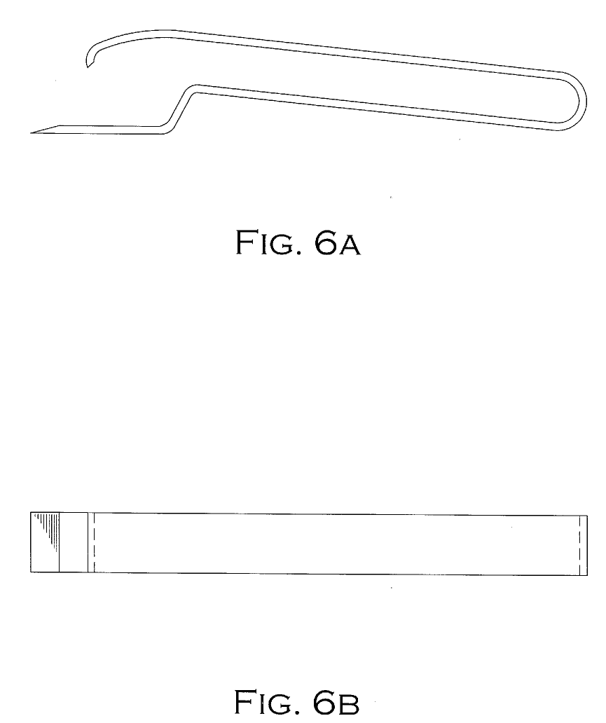

The present invention further provides improved manipulation of material during the cutting operation. As shown in FIG. 6a and FIG. 6b, a grabbing utensil is provided which has a handle and a pair of opposing tine members. The grabbing utensil has an upper tine member and a lower tine member. The upper tine member is recessed or shorter in length from the lower tine member. The lower tine member is angularly protruding from the handle. The angular protrusion provides a gap or space for promoting manipulation of material to be cut. The lower tine member also has an inclined distal end for lifting material to be manipulated. Similar to the cutting device, the inclined distal end of the lower tine provides lift and reduces damage to a surface. The upper tine member has a sharpened distal edge protruding toward the opposing lower tine member. The tine members are further adapted to provide opposing forces which aid in gripping material, such as food, pizza, fabric, or other material commonly cut manually. Thus, the grabbing utensil in combination with the cutting utensil, provides improved cutting operations, reduces damage to surfaces, and promotes sanitary operations.

In one embodiment of the present invention the cutting utensil and grabbing utensil are operably connected to each other. Many connectors may be incorporated within the spirit of the invention. Industrial cleaning environments should be considered when selecting manufacturing material and connector designs, as is well known in the art of kitchen utensils.

The present invention also includes a method of manufacturing a cutting utensil. The method includes providing a first cutting element having a shank section, a first handle, and a blade section with a cutting edge. The method also includes a second cutting element having a shank section, a second handle, and a blade section with a cutting edge and an endpoint, which the method further includes providing the first and second cutting elements operably connected about a rotational pin. The method also includes providing an orthogonal tip operably connected to the endpoint of the second cutting element. While the methods disclosed herein have been described and shown with reference to particular operations performed in a particular order, it will be understood that these operations may be combined, sub-divided, or re-ordered to form equivalent methods without departing from the teachings of the present invention. Accordingly, unless specifically indicated herein, the order and grouping of the operations is not a limitation of the present invention.

It should be appreciated that reference throughout this specification to “one embodiment” or “an embodiment” or “one example” or “an example” means that a particular feature, structure or characteristic described in connection with the embodiment may be included, if desired, in at least one embodiment of the present invention. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the invention.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A cutting device comprising:
a first cutting element having a shank section, a first handle, and a blade section with a cutting edge;
a second cutting element having a shank section, a second handle, and a blade section with a cutting edge and an endpoint;
the first and second cutting elements operably connected about a rotational pin; and
an orthogonal tip operably connected to the endpoint of the second cutting element.

2. A cutting device according to claim 1, wherein the shanks are inclined from the cutting edges.

3. A cutting device according to claim 1, wherein the shanks are inclined from the cutting edges at an angle of at least ten degrees (10°).

4. A cutting device according to claim 1, wherein the orthogonal tip of the second cutting element is adapted to extend beneath a material being cut, the orthogonal tip extending beyond the cutting edges of the cutting device.

5. A cutting device according to claim 4, wherein an underside of the cutting edge of the second cutting element and the orthogonal tip provides cutting stabilization.

6. A cutting device according to claim 5, wherein the orthogonal tip is removably attached to the endpoint of the second cutting element.

7. An angular food scissors comprising:
a first cutting element having a shank section, a first handle section, and a blade section with an upper cutting edge;
a second cutting element having a shank section, a second handle section, and a blade section with a lower cutting edge and an endpoint;
the first and second cutting elements pivotally connected at a point intermediate the blade and shank sections to cause the upper cutting edge of the first cutting element and the lower cutting edge of the second cutting element to be moved between engaged and disengaged positions to provide a cutting action, the shanks being inclined from the cutting edges; and
a protruding orthogonal tip operably connected to the endpoint of the second cutting element, the tip extending orthogonally from the lower cutting edge of the second cutting element.

8. An angular food scissors according to claim 7, wherein the orthogonal tip extends from each side of the lower cutting edge.

9. An angular food scissors according to claim 8, wherein the protruding orthogonal tip further comprises an inclined blunt edge, and wherein the inclined blunt edge is adapted to lift material from a surface.

10. An angular food scissors according to claim 9, wherein the protruding orthogonal tip is distally curved.

11. An angular food scissors according to claim 10, wherein the shanks are inclined from the cutting edges at an angle of at least twenty degrees (20°).

12. An angular food scissors according to claim 11, wherein the protruding orthogonal tip has a predetermined width; and wherein an underside of the blade section of the second cutting element has a predetermined thickness, the predetermined thickness being dependant of the predetermined width of the protruding orthogonal tip.

13. An angular food scissors according to claim 11, wherein the protruding orthogonal tip is removably attached to the endpoint of the second cutting element.

14. An angular food scissors according to claim 11, wherein the protruding orthogonal tip has a width of at least ¾″.

15. A method of manufacturing a cutting device, the method comprising:
providing a first cutting element having a shank section, a first handle, and a blade section with a cutting edge;
operably connecting a second cutting element to the first cutting element about a rotational pin, the second cutting element having a shank section, a second handle, and a blade section with a cutting edge and an endpoint; and
operably connecting an orthogonal tip to the endpoint of the second cutting element.

16. A method according to claim 15 wherein the shanks are inclined from the cutting edges at an angle of between 10 and 20 degrees.

17. A method according to claim 15 wherein the orthogonal tip is removably attached to the end point of the second cutting element.

18. A method according to claim 15 wherein the orthogonal tip is distally curved.

19. A method according to claim 15 wherein the orthogonal tip extends from each side of the lower cutting edge.

20. A method according to claim 15 wherein the orthogonal tip comprises an included blunt edge; and further comprising lifting material from a surface using the inclined blunt edge.
